(19) United States
(12) Patent Application Publication
(10) Pub. No.: US 2005/0141631 A1
(43) Pub. Date: Jun. 30, 2005

(54) Wireless communication system, wireless communication device and wireless communication method, and computer program thereof

(75) Inventor: Hiroaki Takano, Saitama (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Sony Corporation, Tokyo (JP)

(21) Appl. No.: 10/941,809

(22) Filed: Sep. 16, 2004

(30) Foreign Application Priority Data
Dec. 24, 2003 (JP) 2003-426294

(51) Int. Cl. H04L 1/02

(52) U.S. Cl. 375/267

(57) ABSTRACT

The invention realizes an SVD-MIMO transmission having resistance to the variations in the channel characteristic, which saves the feedback from the receiver to the transmitter. The receiver updates the current one into a new channel matrix H_{new} every 100 OFDM symbols, and performs the reception processing by updating the current one into a new decoding weight matrix U_{new} acquired by the singular value decomposition of the channel matrix H_{new}. On the other hand, the transmitter continues to use the original transmission weight matrix V. The diagonal matrix D is turned into a non-diagonal matrix because of the variations in the channel characteristic, where the elements except for the diagonal elements take the values except for zero. This shows that cross talks are generated at this moment. The receiver acquires the cross talk gains, and cancels the cross talk signals of the reception signal to thereby realize the signal transmission without cross talks in consequence.

### BACKGROUND OF THE INVENTION

1. Field of the Invention

The present invention relates to a wireless communication system, with which multiple stations mutually perform wireless communications through a wireless LAN (local area network), more specifically, to a wireless communication system, with which broadband wireless transmissions are implemented, for example, in a home, a wireless communication device and a wireless communication method, and a computer program of the same.

More in detail, the present invention relates to a wireless communication system including a transmitter having multiple antennas and a receiver having multiple antennas that make a pair, which expands the transmission capacity by the communication (MIMO communication) using the space division multiplexing, more specifically, to a wireless communication system that performs the MIMO transmission by using the Singular Value Decomposition (SVD) of a channel information matrix having the channels each corresponding to the antenna pairs of the transmitter and receiver as the elements thereof, a wireless communication device and a wireless communication method, and a computer program of the same.

2. Description of Related Art

A computer networking including a LAN effectively implements the sharing of information resources and device resources. Now, the wireless LAN system attracts general attention, as a system to release users from the LAN wirings by the traditional wired system. The wireless LAN makes it possible to eliminate most of wired cables in a workspace such as an office, and to move communication terminals such as personal computers comparably easily.

In recent years, accompanied with the advancement in high speed and low price of the wireless LAN system, the demand for the system is remarkably increased. In particular, the Personal Area Network (PAN) is under examinations for introduction, which builds up a small-scale wireless network between multiple electronic devices surrounding people to perform information communications. The PAN stipulates different wireless communication systems and wireless communication devices, by using the frequency bands, for example, 2.4 GHz band, 5 GHz band, etc., where the license by the supervisory administrative agency is not necessary.

The IEEE (The Institute of Electrical and Electronics Engineering) 802.11 (see non-patent document 1) can be cited as one example of the standard on the wireless network. The standard IEEE 802.11 is subdivided into the standard IEEE 802.11a, the standard IEEE 802.11b, and so forth depending on the differences of the communication systems and frequency bands to be used.

The standard IEEE 802.11a supports the modulation system that implements the communication speed 54 bps. As the communication speed, however, a wireless standard to realize a much higher bit rate is requested. As a technique to answer such request, the MIMO (multiple-input multiple-output) communication attracts considerable attention recently. The MIMO communication system provides both transmitter and receiver with multiple antennas to attain space division multiplexing transmission channels, namely, logically independent multiple transmission channels (hereunder, called ‘MIMO channels’); thereby, the system accomplishes expanding the transmission capacity and enhancing the communication speed. The MIMO communication system utilizes the space division multiplexing, and accordingly has a higher efficiency of frequency utilization.

FIG. 5 illustrates the MIMO communication system conceptually. As shown in the drawing, both transmitter and receiver have multiple antennas. The transmitter applies the space/time coding to plural transmission data to multiplex transmission signals, distributes the transmission signals having the data multiplexed to M antennas, and transmits them into multiple MIMO channels. The receiver receives the multiplexed transmission signals by N antennas through the MIMO channels, performs the space/time decoding of the transmission signals received, and acquires reception data. Thus, the MIMO communication is different from a simple transmission & reception adaptive array. The channel model in this case is composed of the radio wave environment surrounding the transmitter (transfer function), the channel space structure (transfer function), and the radio wave environment surrounding the receiver (transfer function). Multiplexing the signals transmitted from the antennas involves cross talks. However, it is possible to correctly extract the multiplexed signals without cross talks through the signal processing on the receiver side.

In a word, the MIMO communication system transmits to distribute the transmission data to multiple antennas of the transmitter, and acquires the reception data through the signal processing from the signals received by multiple antennas of the receiver, which is a communication system utilizing the channel characteristics. There are various methods of making up the MIMO transmission, and as one of the realistic forms is known the SVD-MIMO system utilizing the SVD (Singular Value Decomposition) of the transmission channel function (see non-patent document 2).

FIG. 6 illustrates the SVD-MIMO transmission system conceptually. The SVD-MIMO transmission system performs the singular value decomposition of a numerical matrix having the channel information corresponding to the antenna pairs as the elements, namely, a channel information matrix H to calculate UVD^{H}, and provides the transmitter with V as the antenna weighting coefficient matrix and provides the receiver with U^{H} as the antenna weighting coefficient matrix. Thereby, each of the MIMO channels can be expressed as a diagonal matrix D having the square root of each eigenvalue λᵢ as the diagonal elements, thus transmitting to multiplex signals without any cross talks.

However, it is not easy to execute the arithmetic calculation of the singular value decomposition in real time, and attention must be paid to the necessity of a setup process that the derived V or U^{H} has to be informed to the other party in advance.

The SVD-MIMO transmission system achieves the maximum communication capacity in theory; if both transmitter and receiver have two antennas, for example, the system acquires double the transmission capacity at the maximum.

Now, the mechanism of the SVD-MIMO transmission system will be described in detail. If the transmitter has M antennas, the transmission signal x can be expressed as the vector M×1. And, if the receiver has N antennas, the reception signal y can be expressed as the vector N×1. In this case, the channel characteristic can be expressed as the numerical matrix H of N×M. The element hᵢⱼ of the channel information matrix H represents the transfer function from the j-th transmission antenna to the i-th reception antenna. And, the reception signal vector y can be expressed as the following formula (1), as a form of multiplying the transmission signal vector and the channel information matrix, and further adding a noise vector n.
y=Hx+n (1)

If the singular value decomposition of the channel information matrix H is performed, it will acquire the following formula (2).
H=UDV^{H} (2)

Here, the antenna weighting coefficient matrix V on the transmitter side and the antenna weighting coefficient matrix U on the receiver side are the unitary matrices that meet the following formulas (3) and (4).
U^{H}U=I (3)
V^{H}V=I (4)

That is, the antenna weighting coefficient matrix U^{H} on the receiver side is the matrix in which the eigenvectors with HH^{H} normalized are arrayed, and the antenna weighting coefficient matrix V on the transmitter side is the matrix in which the eigenvectors with H^{H}H normalized are arrayed. D is the diagonal matrix, which has the square root of the eigenvalue of HH^{H} or H^{H}H as the diagonal elements. The magnitude of D is equal to the smaller one of the number M of the transmission antennas and the number N of the reception antennas. D is a square matrix and a diagonal matrix having the magnitude of min (M, N).

$$D = [ \begin{matrix}\sqrt{{λ}_{1}} & ⋯ & & 0 \\ ⋮ & \sqrt{{λ}_{2}} & & \\ & & ⋰ & \\ 0 & & & \sqrt{{λ}_{min ( M , N )}}\end{matrix} ] \qquad ( 5 )$$

The above description relates to the singular value decomposition in the real number. However, there are some points to notice, when the singular value decomposition is developed into the imaginary number. U and V are the matrices composed of eigenvectors. But if an operation to make the norms of the eigenvectors into 1, that is, the normalization is performed, these matrices will not be made unitary, and there exist innumerable eigenvectors having different phases. There are some cases where the above formula (2) cannot be met, depending on the phase relation of U and V. That is, U and V are individually correct, but only the phases thereof turn arbitrarily. In order to put the phases into complete coincidence, V is calculated as the eigenvectors of H^{H}H according to the general rule, and U is calculated by multiplying both sides of the formula (2) with V, as the following formula.
HV=UDV^{H}V=UDI=UD (6)
U=HVD⁻¹

If the transmitter applies the weighting with the antenna weighting coefficient matrix V, and the receiver applies the weighting with the antenna weighting coefficient matrix U^{H}, since U and V are the unitary matrices (U=N×min (M, N), V=M×min (M, N)), the reception signal vector y will be given by the following formula.

$$\begin{matrix}y = {U}^{H} HVx + {U}^{H} n \\ = {U}^{H} ( {UDV}^{H} ) Vx + {U}^{H} n \\ = ( {U}^{H} U ) D ( {V}^{H} V ) x + {U}^{H} n \\ = IDIx + {U}^{H} n \\ y = Dx + {U}^{H} n\end{matrix} \qquad ( 7 )$$

Here, the reception signal y and the transmission signal x are not the vectors determined by the numbers of the transmission antennas and reception antennas, but the vectors (min (M, N)×1).

Since D is a diagonal matrix, the transmission signals each can be received without cross talks. Since the amplitudes of the independent MIMO channels each are proportional to the square root of the eigenvalue λ, the magnitudes of the powers of the MIMO channels each are proportional to λ.

In regard to the noise vector n, since the columns of U are the eigenvectors with the norms thereof normalized into 1, U^{H}n is not to vary the noise power thereof. U^{H}n has the magnitude of the vector (min (M, N)×1), which is the same magnitude as that of y or x.

Thus, the SVD-MIMO transmission is able to acquire logically independent multiple MIMO channels without cross talks, while the channels use an identical frequency and an identical time base. In other words, the SVD-MIMO transmission makes it possible to transmit multiple data through wireless communications by using the same frequency at the same time, and to realize enhancement of the transmission speed.

Now in the SVD-MIMO transmission system, it is necessary to acquire the channel information matrix H on the receiver side and perform the singular value decomposition of this H, and to transmit V^{H} of UDVH thus decomposed to the transmitter side. Since V is used in the transmitter in reality, V has to be transmitted to the transmitter.

Using the standard IEEE 802.11a being one of the LAN system to which the SVD-MIMO transmission system is applied, that is, the OFDM (Orthogonal Frequency Division Multiplexing) communication system of 5 GHz pair as an example, the discussion will be made as to the information quantity of the antenna weighting coefficient matrix V on the transmitter side.

If both transmitter and receiver have 3 antennas, the antenna weighting coefficient matrix V on the transmitter side becomes a 3×3 matrix, and the number of the elements thereof is 9. Provided that the matrix is expressed by the real numbers and imaginary numbers of 10 bits-accuracy per one element, and the system needs the matrices for 52 carriers, the receiver has to feed back 9360 bits (=9(number of the matrix elements)×2(real part and imaginary part of a complex number)×10 (bits)×52 (number of OFDM sub-carrier)) to the transmitter.

The MIMO communication system that needs the feedback in this manner is called the closed loop type MIMO. In the closed loop type SVD-MIMO system, the receiver has to feed back as much information quantity as 9360 bits to the transmitter when starting the communication. Now, if a trial to feed back the above information quantity is made with the OFDM of the modulation system using the BPSK (Binary Phase Shift Keying) provided by the standard IEEE 802.11a, of which reliability is considered as the highest, and the code rate of ½, since only 24 bits can be transmitted by 1 OFDM symbol, it takes as much time as corresponding to 390 OFDM symbols, which is not realistic.

While the communication is started when the antenna weighting coefficient matrix V is transmitted in the first place from the receiver to the transmitter, the elements of the channel matrix H (namely, the transfer function) vary with age. This variation with age of the channel matrix H is mainly caused by the variations of reflection channels accompanied with the moves of people and goods in a building, and the variations of the temperature.

When the channel characteristic varies with time in this manner, it is necessary for the receiver to acquire the channel matrix H again, perform the singular value decomposition of the new H, feed back a new antenna weighting coefficient matrix V to the transmitter, request the transmitter to send data weighted by the new V (namely, relearning of V), and decode the reception signal with the new U^{H}.

If the receiver acquires the channel matrix and the transmitter performs the relearning of V at intervals of 100 OFDM symbols (about 40 microseconds), for example, it will require an excessive overhead. In case the transmitter is transmitting long packets to the receiver, for example, in order for the transmitter to perform the relearning of V in the meantime, the receiver breaks the reception temporarily and has to perform a backward communication for the feedback of V, which is extremely inconvenient. The reason lies in that the backward communication from the receiver to the transmitter lowers the transmission capacity as well as requires the sequential acquisition of synchronization.

In short, the SVD-MIMO transmission is required to follow the variations of the channel characteristic without using a feedback route.

[nonpatent document 1] International Standard ISO/IEC 8802-11:1999 (E) ANSI/IEEE Std 802.11, 1999 Edition, Part 11: Wireless LAN Medium Access Control (MAC) and Physical Layer (PHY) Specifications

[nonpatent document 2] http://radio 3.ee.uec.ac.jp/MIMO (IEICE_TS).pdf (as of Oct. 24, 2003)

### SUMMARY OF THE INVENTION

An object of the invention is to provide an excellent wireless communication system and wireless communication method, and wireless communication device, which realizes a broadband wireless transmission under a domestic communication environment.

Another object of the invention is to provide an excellent wireless communication system and wireless communication method, and wireless communication device, which expands the transmission capacity by the communication (MIMO communication) using the space division multiplexing, where a transmitter having multiple antennas and a receiver having multiple antennas make a pair.

Another object of the invention is to provide an excellent wireless communication system and wireless communication method, and wireless communication device, which suitably performs the MIMO transmission using the singular value decomposition (SVD) of a channel information matrix having the channels each corresponding to the antenna pairs of the transmitter and receiver as the elements thereof.

Another object of the invention is to provide an excellent wireless communication system and wireless communication method, and wireless communication device, which has resistance to the variations of the channel characteristic in the SVD-MIMO transmission, and makes unnecessary the sequential feedback to the transmitter from the receiver.

The invention has been made in view of the above problems. According to the first aspect of the invention, the wireless communication system includes a pair of a transmitter having multiple antennas and a receiver having multiple antennas, and multiplexes signals for communication. Here, the transmitter transmits a reference signal. The receiver, receiving the reference signal, calculates a channel matrix H, performs the singular value decomposition of the channel matrix H into UDV^{H} to acquire a reception weight matrix U^{H}, a diagonal matrix D, and a transmission weight matrix V, and processes a reception signal using the reception weight matrix U^{H}. And, when cross talks are generated between channels, the receiver calculates cross talk gains, estimates cross talk signals from the cross talk gains, and cancels the cross talk signals of the reception signal.

The ‘system’ mentioned herein represents a logical aggregation of plural devices (or functional modules to realize specific functions). It is irrelevant whether the devices or functional modules are assembled in a signal enclosure or not.

The wireless communication system relating to the invention adopts the SVD-MIMO transmission system, which performs the singular value decomposition of the numerical matrix having the channel information corresponding to the antenna pairs as the elements, namely, the channel information matrix H to calculate UVD^{H}, and provides the transmitter with V as the antenna weighting coefficient matrix and provides the receiver with U^{H} as the antenna weighting coefficient matrix. Thereby, each of the MIMO channels can be expressed as a diagonal matrix D having the square root of each eigenvalue λᵢ as the diagonal elements, thus transmitting to multiplex signals without any cross talks.

When the elements of the channel matrix H (namely, the transfer function) vary with age, it is necessary for the receiver to acquire the channel matrix H again and perform the singular value decomposition of a new H to update the reception weight matrix U, and for the transmitter to perform the relearning of a new transmission weighting coefficient matrix V. The relearning of V involves lowering of the transmission capacity, since the relearning requires the backward communication, namely, the feedback from the receiver to the transmitter.

Thus in this invention, the receiver updates the channel matrix at predetermined intervals, but does not perform the feedback to the transmitter at all.

As the result, the receiver performs the reception processing by updating the current one into the new decoding weight matrix U_{new} acquired by the singular value decomposition of the updated channel matrix H_{new}; on the other hand, the transmitter continues to use the original transmission weight matrix V. Because the transmitter does not update the transmission weight matrix regardless of the variations in the channel characteristic, cross talks are generated between the logically independent multiple MIMO channels formed by the SVD-MIMO transmission.

To cope with this problem, the invention acquires the cross talk gains on the receiver side, and cancels the cross talk signals of the reception signal to thereby realize the signal transmission without cross talks in consequence.

One method of canceling the cross talk signals of the reception signal is: calculating a general inverse matrix Dₑᵣᵣₒᵣ⁻ of a matrix Dₑᵣᵣₒᵣ turned into a non-diagonal matrix by the generation of the cross talk signals, multiplying a resultant signal after the reception signal having been received with the reception weight matrix by the inverse matrix Dₑᵣᵣₒᵣ⁻, and determining the result as a final reception signal.

Another method of canceling the cross talk signals is: calculating the cross talk gains to the MIMO channels each, estimating the cross talk signals, and subtracting the cross talk signals from the reception signal.

According to the second aspect of the invention, the computer program is described in a computer-readable format, in a manner that the processing for receiving multiplexed signals from a transmitter having multiple antennas with multiple antennas is executed on a computer system. The computer program includes: a channel estimating step of calculating a channel matrix H from a reference signal transmitted from a transmitter; a singular value decomposition step of performing the singular value decomposition of the channel matrix H into UDVH to acquire a reception weight matrix U^{H}, a diagonal matrix D, and a transmission weight matrix V; a reception signal processing step of processing a reception signal using the reception weight matrix U^{H}; a cross talk estimating step of estimating cross talk gains of the channels each; and a cross talk removing step of estimating cross talk signals based on the cross talk gains, and removing the cross talk signals from the reception signal processed in the reception signal processing.

The computer program relating to the second aspect of the invention is described in a computer-readable format, in a manner that a predetermined processing is implemented on a computer system. In other words, by installing the computer program relating to the second aspect of the invention in a computer system, the computer program displays cooperative functions on the computer system to operate as a wireless communication device. By starting multiple wireless communication devices as such to build up a wireless network, it is possible to achieve the same functions and effects as those of the wireless communication system relating to the first aspect of the invention.

According to the invention, it is possible to provide an excellent wireless communication system and wireless communication method, and wireless communication device, which expands the transmission capacity by the communication (MIMO communication) using the space division multiplexing, where a transmitter having multiple antennas and a receiver having multiple antennas make a pair.

According to the invention, it is possible to provide an excellent wireless communication system and wireless communication method, and wireless communication device, which suitably performs the MIMO transmission using the singular value decomposition (SVD) of a channel information matrix having the channels each corresponding to the antenna pairs of the transmitter and receiver as the elements thereof.

According to the invention, it is possible to provide an excellent wireless communication system and wireless communication method, and wireless communication device, which has resistance to the variations of the channel characteristic in the SVD-MIMO transmission, and makes unnecessary the sequential feedback to the transmitter from the receiver.

The SVD-MIMO transmission system displays the maximum transmission capacity among various MIMO transmission systems, but it has to feed back the transmission weight matrix V to the transmitter from the receiver. According to the invention, it is possible to significantly prolong the time interval for the feedback, that is, the cycle for the relearning of V. As to how far the cycle can be prolonged, it varies depending on the environment under which the system is used, that is, the variations of transmission channels and the strengths of the modulation system and error correction system, and so forth.

Incidentally, in addition to the above-mentioned related art, there have been proposed by the present inventors techniques related to the present invention as disclosed in unpublished Japanese Patent Application Nos. 2003-375504, 2004-040934, 2004-140485, 2004-140488, and 2004-140486.

Other objects, features, and advantages of the invention will become apparent from the detailed descriptions based on the preferred embodiments of the invention described later, and the appended drawings thereof.

### BRIEF DESCRIPTION OF THE DRAWINGS

FIG. 1 illustrates a schematic construction of a communication system by the SVD-MIMO transmission system relating to one embodiment of the invention;

FIG. 2 illustrates a construction of the OFDM communication system to which the invention is applied;

FIG. 3 illustrates a packet configuration transmitted from the transmitter;

FIG. 4 is a flowchart illustrating the processing steps of the SDM-MIMO transmission in the OFDM communication system illustrated in FIG. 3;

FIG. 5 is a conceptual illustration of the MIMO communication system;

FIG. 6 is a conceptual illustration of the SDM-MIMO transmission system; and

FIG. 7 is a conceptual illustration of a communication system by the V-BLAST transmission system.

### DETAILED DESCRIPTION OF THE PREFERRED EMBODIMENTS

The preferred embodiments of the invention will be described in detail with reference to the accompanying drawings.

The SVD-MIMO transmission system performs the singular value decomposition of a numerical matrix having the channel information corresponding to the antenna pairs as the elements, namely, the channel information matrix H to calculate UVD^{H}, and provides the transmitter with V as the antenna weighting coefficient matrix and provides the receiver with U^{H} as the antenna weighting coefficient matrix. Thereby, each of the MIMO channels can be expressed as a diagonal matrix D having the square root of each eigenvalue λᵢ as the diagonal elements, thus transmitting to multiplex signals without any cross talks.

Instead of performing the singular value decomposition of the channel information matrix H acquired by the receiver into UVD^{H}, and feeding back the antenna weighting coefficient matrix V thereby acquired to the transmitter, this embodiment transmits a reference symbol from the receiver to the transmitter, performs the singular value decomposition also on the transmitter side, and acquires the antenna weighting coefficient matrix V necessary for transmission. Thereby, it is possible to compress the information quantity of the feedback from the receiver to the transmitter.

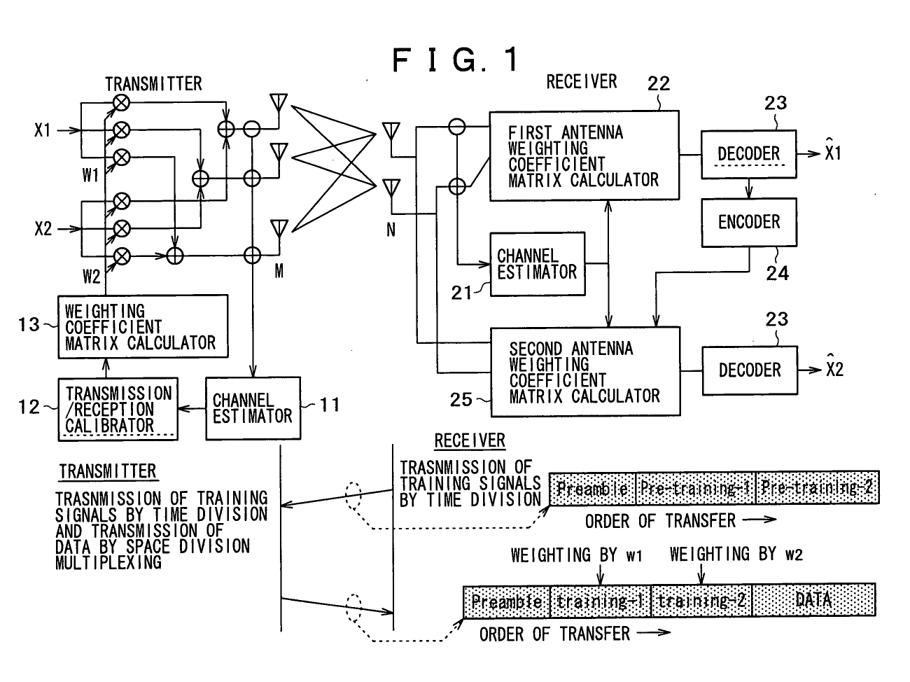

FIG. 1 illustrates a schematic construction of a communication system by the SVD-MIMO transmission system relating to this embodiment of the invention.

The transmitter performs the space/time coding of transmission signals to be multiplexed, distributes the transmission signals to 3 antennas, and transmits them into the channels. The receiver performs the space/time decoding of the multiplexed transmission signals received by 2 antennas trough the channels, and acquires reception data.

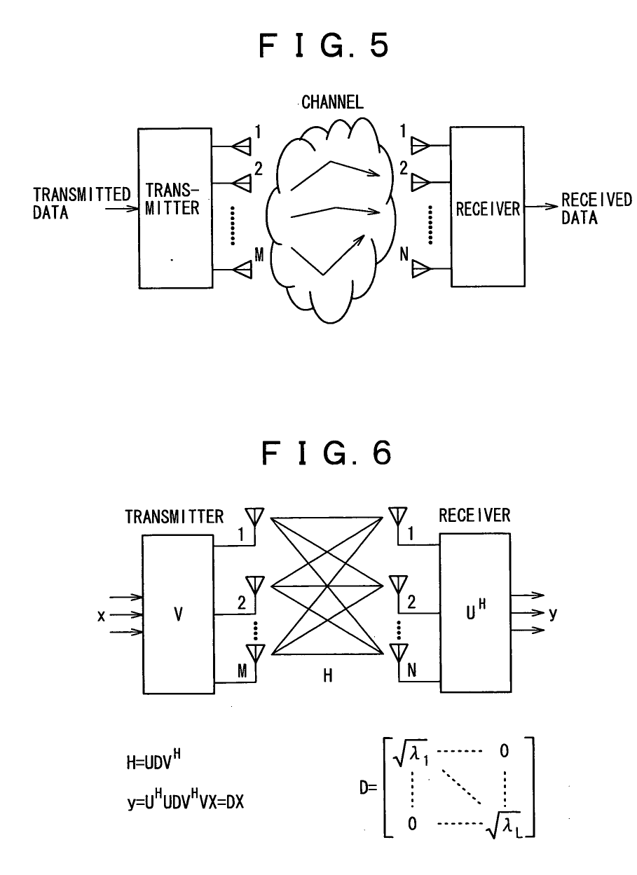

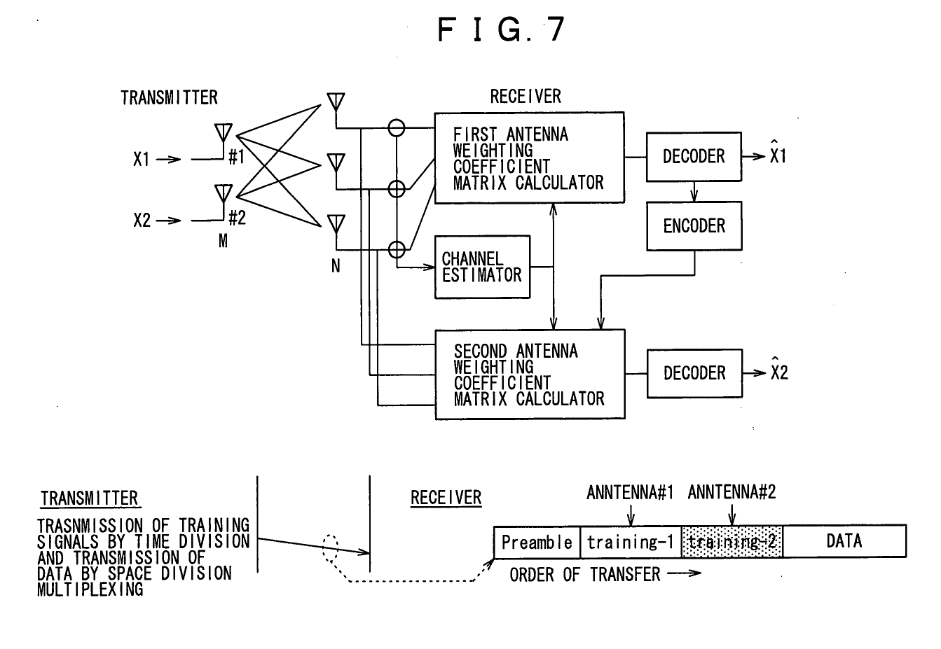

The communication system as shown in the drawing is roughly similar to the V-BLAST system. However, it is clearly different from the system as shown in FIG. 5 in that the transmitter is designed to give antenna weighting coefficients in transmission, and the transmitter antenna number is made larger than the reception antenna number (=signal multiplexing number).

The system construction as shown in FIG. 1 yields an excessive degree-of-freedom (DOF) to the transmitter having more antennas. However, the system executes the MNS transmission or the Zero-forcing transmission, or the transmission giving a weighting coefficient with the MNS and Zero-forcing combined to the reception antennas, in order to make this excessive DOF contribute to increasing the SN ratio of the reception signal. Here, the MNS is the abbreviation of Maximum Signal-To-Noise ratio, and the norm to maximize the SN ratio of its own signal. As the result, though the receiver does not have an excessive DOF of the antennas (the receiver has fewer antennas), the excessive DOF on the transmitter side compensates for the scanty DOF on the receiver side, thereby achieving a satisfactory decoding performance.

The operational process in the communication system of this embodiment will be described hereunder.

At the first preparatory stage, a receiver 20 transmits a training signal Pre-training Signal as the reference symbol from each of the reception antennas by the time division. Since the receiver 20 has two reception antennas in the illustrated example, the receiver transmits two training signals. Here, the Preamble connected directly before the Pre-training signal is an added signal for the signal detection, timing synchronization, and/or reception gain adjustment.

A transmitter 10 receives the training signal from the receiver 20 as the reference signal, a channel estimator 11 calculates a channel information matrix H, and a transmission weighting coefficient matrix calculator 13 determines a transmission antenna weighting coefficient matrix Z_{T} based on the MNS norm, Zero-forcing norm, or a combination of these norms to each of the reception antennas.

Following this, the transmitter 10 transmits the transmission signal in which the training signal and a space-divided multiplexed signal are connected. Here, as the antenna weight is given the above determined Z_{T}. Also in the transmission interval of the training signal is given the antenna weight of each multiplexed signal. In the illustrated example, the weighting coefficients by the element vectors w₁ and w₂ of the antenna weighting coefficient matrix Z_{T}(=[w₁, w₂]) are each given to a Training-1 and a Training-2 as the training signal, which are transmitted by means of the time-division.

On the side of the receiver 20, a channel estimator 21 calculates a channel information matrix H′ corresponding to the transmission weighting coefficient vector and the receiver antenna pair from the training signal Training-1 and Training-2 having the weight given to each of the multiplexed signals.

And, a first reception antenna weighting coefficient matrix calculator 22 applies the Zero-forcing norm or the like to each of the transmission antennas, and thereby cancels all of undesired signals, namely, signals other than it own signal, and determines a reception antenna weighting coefficient matrix Z_{R}. A decoder 23 first performs the decoding of X₁ to the signal of the highest SN ratio among the received signals extracted after giving this Z_{R}.

Next, an encoder 24 encodes the decoded signal again to produce a replica of the transmission signal, and eliminates the transmission signal of the replica from the received signals directly after the antennas. A second reception antenna weighting coefficient matrix calculator 25 excludes the transmission antennas corresponding to the eliminated transmission signals, applies the Zero-forcing norm again to the remaining transmission antennas, and recalculates the reception antenna weighting coefficient matrix to produce a new Z_{R′}. The decoder 23 performs the decoding of X₂ to the signal of the highest SN ratio among the remaining received signals. The second decoding attains the effect of increasing the DOF of the reception antennas to the extent that the firstly decoded transmission signal is excluded, and raising the MSN ratio synthesizing effect to that extent. Hereafter, repeating the above operations will sequentially decode all the multiplexed transmission signals.

Thus, the communication system as shown in FIG. 1, while performing the transmission with the weighting coefficient by the MSN norm, the Zero-forcing norm, or a combination of these norms from the transmitter 10, creates such a mechanism that makes full use of the DOF of transmission antennas and increases the reception SN ratio. Therefore, if the DOF of reception antennas is scanty, the excessive DOF of the transmission antennas can compensate this scantiness.

As mentioned above, the transmitter can achieve the MIMO transmission by acquiring the antenna weighting coefficient matrix V. However, as the elements of the channel matrix H (namely, transfer function) vary with age, it is necessary for the receiver to acquire the channel matrix H again and perform the singular value decomposition of a new H, and for the transmitter to perform the relearning of a new transmission weighting coefficient matrix V. The relearning of V requires the backward communication, such as the feedback of V from the receiver to the transmitter, and the transmission of the reference symbol.

The case will be examined, where the channels are given such variations as demanding to update the matrix by acquiring a new channel matrix every 100 OFDM symbols.

The transmitter transmits the reference symbol for acquiring a new channel matrix every 100 OFDM symbols. The receiver receives the reference signal every 100 OFDM symbols, and acquires a new transfer function to thereby acquire a new channel matrix H′.

Here, it is assumed that the original channel matrix is H, and the singular value decomposition of this is H=UDV^{H}. It is also assumed that the new channel matrix updated after 100 OFDM symbols by the receiver is H_{new}, and the singular value decomposition of this is H_{new}=U_{new}D_{new}V_{new}^{H}.

If the receiver feeds back the transmission weighting coefficient matrix V_{new} calculated from the updated channel matrix H_{new} by the singular value decomposition to the transmitter, the communication system will be able to follow the variations of the channel characteristic. However, the backward communication from the receiver to the transmitter lowers the transmission capacity, and also requires the sequential acquisition of synchronization.

Thus in this invention, the receiver updates the channel matrix every 100 OFDM symbols, but does not perform the feedback (including the transmission of the reference symbol) to the transmitter at all. As the result, the receiver updates the current one into the new decoding weight matrix U_{new} acquired by the singular value decomposition of the updated channel matrix H_{new} to perform the reception processing; on the other hand, the transmitter continues to use the original transmission weight matrix V.

Because the transmitter does not update the transmission weight matrix regardless of the variations in the channel characteristic, cross talks are generated between the logically independent multiple MIMO channels formed by the SVD-MIMO transmission. This will be explained hereunder.

Before the variations appear in the channel characteristic, the singular value decomposition can be performed as the following formula. The transmitter and the receiver can use the transmission weight matrix V and the reception weight matrix U, respectively, and the receiver can extract the signal without cross talks.
H=UDV^{H} (8)

After the variations appeared in the channel characteristic, the receiver can perform the singular value decomposition of the new channel matrix H_{new} as the following formula, and use the information.
H_{new}=U_{new}D_{new}V_{new}^{H} (9)

Although the singular value decomposition is performed as the formula (9), the actual communication takes such a form as the following formula, because the receiver uses the new reception weight matrix U_{new}^{H}, while the transmitter continues to use the original transmission weight matrix V.
H_{new}=U_{new}DₑᵣᵣₒᵣV^{H} (10)

The original D acquired by the singular value decomposition of the channel matrix as given by the above formula (8) can be expressed as a diagonal matrix having the square root of each eigenvalue λᵢ as the diagonal elements. Since each of these diagonal elements λ_{I} corresponds to each of the MIMO channels, and the remaining matrix elements are zero, the channels find to be mutually independent channels not having cross talks at all. In this case, the reception signal vector y can be expressed as the product of the transmission signal vector x and the diagonal matrix D, as shown in the above formula (7), which yields multiple MIMO channels without cross talks.

In contrast, when the transmitter continues to use the original transmission weight matrix V instead of the new transmission weight matrix V_{new} after the variations appeared in the channel characteristic, the elements except for the diagonal elements of Dₑᵣᵣₒᵣ given by the above formula (10) will take the values except for zero, and the matrix will be turned into a non-diagonal matrix. This means that cross talks are generated between the multiple independent MIMO channels.

If the transmitter applies the weighting to the new channel matrix H_{new} with the original weight matrix V, and the receiver applies the weighting with the new weight matrix U_{new}^{H}, since V and U_{new} both are the unitary matrices, the reception signal vector y can be expressed as the product of the transmission signal vector x and the non-diagonal matrix Dₑᵣᵣₒᵣ as shown in the following formula (here, the noise component is omitted), which shows that there appear multiple MIMO channels with cross talks.
y=Dₑᵣᵣₒᵣx (11)

Accordingly, this embodiment intended to realize the signal transmission without cross talks in consequence, by the receiver calculating the cross talk gains when cross talks are generated and removing the cross talk signals from the reception signal.

The diagonal matrix where the cross talks are not present is a diagonal matrix having the square root of each eigenvalue λᵢ of HH^{H} or H^{H}H as the diagonal elements, as shown by the above formula (5). In contrast, the non-diagonal matrix Dₑᵣᵣₒᵣ where the cross talks are present is expressed as the following formula.

$$D = [ \begin{matrix}\sqrt{{λ}_{1}} & {a}_{12} & ⋯ & a … \\ {a}_{21} & \sqrt{{λ}_{2}} & & \\ & & ⋰ & \\ a … & & & \sqrt{{λ}_{min ( M , N )}}\end{matrix} ] \qquad ( 12 )$$

In short, the matrix D is a diagonal matrix in its self, if there are not cross talks. The elements except for the diagonal elements are essentially zero, but if there are cross talks, the cross talk components appear in the elements except for the diagonal elements. In the formula (12), aᵢⱼ signifies the cross talk gain from the j-th MIMO channel to the i-th MIMO channel.

In the above formula (10), the new channel matrix H_{new} is already known, since the receiver acquires it. And, the receiver can acquire U_{new} by performing the singular value decomposition of the new channel matrix H_{new}. Further, V is the transmission weight matrix calculated from the original channel matrix H, which is already known by the receiver. Therefore, the non-diagonal matrix Dₑᵣᵣₒᵣ can be calculated according to the following formula. Here, U_{new}⁻ is the general inverse matrix of U_{new}, and V^{H-} is the general inverse matrix of V^{H}.
Dₑᵣᵣₒᵣ=U_{new}⁻H_{new}V^{H-} (13)

Therefore, all of the cross talk gain aᵢⱼ given by the formula (12) can be calculated by the formula (13).

As a method of canceling the cross talk signals of the reception signal on the receiver side, the following steps can be taken: after acquiring the non-diagonal matrix Dₑᵣᵣₒᵣ, further calculating the general inverse matrix Dₑᵣᵣₒᵣ⁻ thereof, multiplying a resultant signal after the reception signal having been received with the reception weight matrix by the inverse matrix Dₑᵣᵣₒᵣ⁻, and determining the result as a final reception signal.
y=Dₑᵣᵣₒᵣ⁻U_{new}^{H}H_{new}Vx (14)

Here, y is the reception signal to be acquired, x is the transmission signal, H_{new} is the new channel matrix, U_{new}^{H} is the reception weight matrix calculated from the new channel matrix, V is the transmission weight matrix calculated from the original channel matrix. The general inverse matrix signifies an inverse matrix of a non-squire matrix, for which can be used the Moore-Penrose type general inverse matrix.

Another method of canceling the cross talk signals is estimating the cross talk signals from the cross talk gain a to the MIMO channels calculated from the formula (13), and subtracting the estimated cross talk signals from the reception signal. Now, assuming that the original transmission signal of the j-th MIMO channel is x, and the error component thereof is xₑᵣᵣₒᵣ, the cross talk signal from the j-th MIMO channel to the i-th MIMO channel is expressed as the following formula.

$${C}_{ij} = {a}_{ij} \times ( x + {x}_{error} ) \\ = {a}_{ij} \times x + {a}_{ij} \times {x}_{error} \\ \approx {a}_{ij} \times x \qquad ( 15 )$$

Here, the formula (15) uses aᵢⱼ×xₑᵣᵣₒᵣ≈0. Because the cross talk component aᵢⱼ is sufficiently small at the initial stage, and the error component xₑᵣᵣₒᵣ from the original transmission signal x is also small, the multiplication of both the small values can be regarded as zero.

As an excessively long time elapses, this part cannot be regarded as zero, and the cross talks cannot be eliminated normally. Therefore, not to update V permanently is not allowed, and it is recommended to keep the effectiveness for a long time. This is to have the durability against the variations of the transmission channels.

Next, the embodiment to cancel the aforementioned cross talk components will be described in a communication system provided with the OFDM modulation system operating over 5 GHz band, where both transmitter and receiver have three antennas.

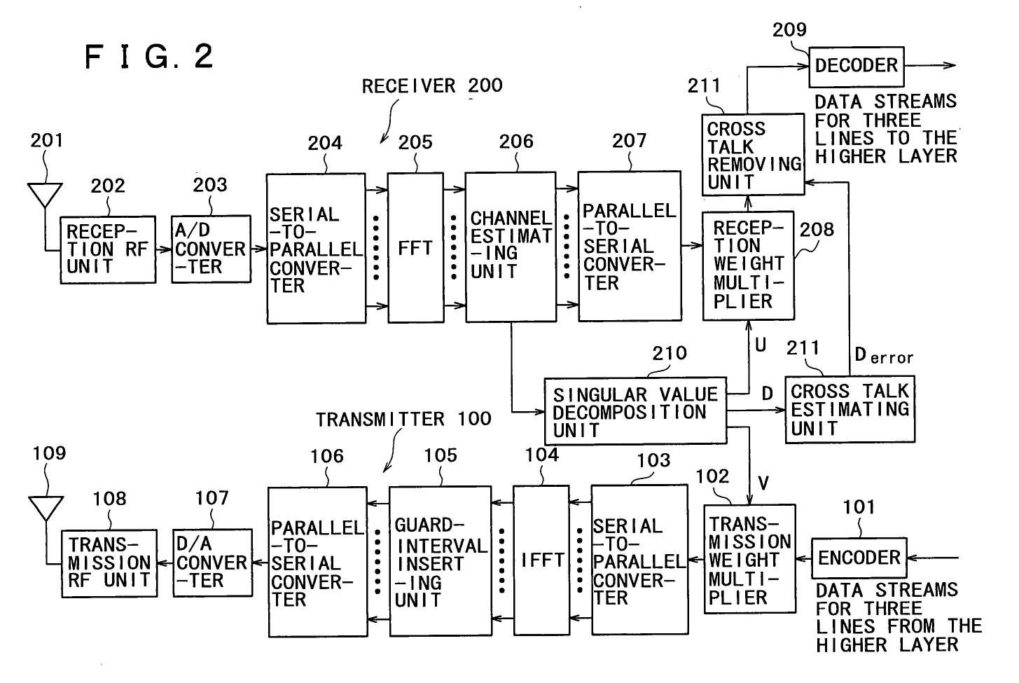

FIG. 2 illustrates a construction of the OFDM communication system relating to this embodiment.

A transmitter 100 includes an encoder 101, a transmission weight multiplier 102, a serial-to-parallel converter 103, an IFFT 104, a guard-interval inserting unit 105, a parallel-to-serial converter 106, a D/A converter 107, a transmission RF unit 108, and an antenna 109.

The encoder 101 encodes a transmission signal sent from the higher layer of the communication protocol with a specific error correction code. At this stage, the well-known data sequence may be inserted into the modulation symbol sequence as a pilot symbol. The pilot signal composed of the well-known pattern is inserted at sub-carriers each, or at intervals of several sub-carriers.

The transmission weight multiplier 102 holds the transmission weight matrix V, which is acquired by performing the singular value decomposition of the channel matrix H acquired by receiving several reference symbols equivalent to the transmission antenna number to estimate the channel, and multiplies the transmission signal after encoding by this weight matrix V.

The serial-to-parallel converter 103 converts a modulated serial format signal into several parallel data of which number corresponds to the parallel carrier number, according to the parallel carrier number and the timing.

The IFFT 104 performs the inverse Fourier transform corresponding to the FFT size according to a predetermined FFT size and timing. The guard-interval inserting unit 105 sets a guard-interval section before and after 1 OFDM symbol in order to eliminate inter-symbol interferences. The time span of the guard interval is determined depending on the condition of the transmission channels, that is, the maximum delay time of the delayed waves affecting the demodulation.

The parallel-to-serial converter 106 mends the parallel incoming signals into a serial format signal, and converts it into a signal on the time base, while the orthogonality on the frequency axis of each carrier is maintained, and outputs the signal as a transmission signal. The transmission signal is converted into an analog base band signal by the D/A converter 107, which is further up-converted into an RF band signal by the transmission RF unit 108, and then transmitted into the channels through the antenna 109.

On the other hand, a receiver 200 includes an antenna 201, a reception RF unit 202, a A/D converter 203, a serial-to-parallel converter 204, a FFT 205, a channel characteristic estimating unit 206, a parallel-to-serial converter 207, a reception weight multiplier 208, and a decoder 209.

The reception RF unit 202 down-converts a signal received by the antenna 201 from the RF band to the base band, and the A/D converter 203 converts the signal into a digital signal.

The serial-to-parallel converter 204 converts the reception signal as serial data into parallel data according to the detected synchronizing timing. Here, the data are collected which correspond to 1 OFDM symbol including the guard interval.

The FFT 205 performs the Fourier transform of a signal corresponding to the effective symbol length, and extracts the signals of the sub-carriers each.

The channel characteristic estimating unit 206 acquires the channel matrix H with the reference signal to which the transmitter gave the weight by each of the multiplexed signals. A singular value decomposition unit 210 performs the singular value decomposition of this channel matrix H, and acquires the transmission weight matrix V, reception weight matrix U, and diagonal matrix D. The transmitter sends the reference signal at predetermined intervals (every 100 OFDM symbols, in this embodiment). The channel characteristic estimating unit 206 updates the channel matrix on all such occasions, and the singular value decomposition unit 210 performs the singular value decomposition of the updated channel matrix.

Thereafter, the parallel-to-serial converter 207 converts a signal on the time base into a signal on the frequency axis. The reception weight multiplier 208 multiplies the reception signal by the reception weight matrix U acquired through the singular value decomposition of the channel matrix H.

The decoder 209 decodes the weighted reception signal and the error correction code encoded therein to make a reception data, which is transferred to the higher layer of the communication protocol.

And, when the elements of the channel matrix H vary with age, it is necessary for the receiver to acquire the channel matrix H again and perform the singular value decomposition of a new H, and for the transmitter to perform the relearning of a new transmission weighting coefficient matrix V. However, the backward communication from the receiver to the transmitter lowers the transmission capacity, and requires the sequential acquisition of synchronization. Therefore, the receiver updates the channel matrix every 100 OFDM symbols, but does not perform the feedback to the transmitter at all.

As the result, the receiver updates the current one into the new decoding weight matrix U_{new} acquired by the singular value decomposition of the updated channel matrix H_{new} to perform the reception processing; on the other hand, the transmitter continues to use the original transmission weight matrix V. Because the transmitter does not update the transmission weight matrix, cross talks are generated between the logically independent multiple MIMO channels formed by the SVD-MIMO transmission.

And, when there appear some cross talks, a cross talk estimating unit 211 acquires the cross talk gains, and a cross talk removing unit 212 removes the cross talk signals from the reception signal.

Assuming that the cross talk gain from the j-th MIMO channel to the i-th MIMO channel is given by aᵢⱼ, the diagonal matrix D before cross talks are generated is turned into the non-diagonal matrix Dₑᵣᵣₒᵣ having the cross talk gain aᵢⱼ as the non-diagonal elements, after cross talks are generated (see the formula (12)). The cross talk estimating unit 211 calculates the non-diagonal matrix Dₑᵣᵣₒᵣ from the channel matrix H updated at predetermined intervals (every 100 OFDM symbols) by using the formula (13).

And, the cross talk removing unit 212 cancels the cross talk signals of the reception signal, by using the acquired non-diagonal matrix Dₑᵣᵣₒᵣ. The method of canceling the cross talk signals of the reception signal, after acquiring the non-diagonal matrix Dₑᵣᵣₒᵣ, further calculates a general inverse matrix Dₑᵣᵣₒᵣ⁻ thereof, multiplies a resultant signal after the reception signal having been received with the reception weight matrix by the inverse matrix Dₑᵣᵣₒᵣ⁻, and determines the result as a final reception signal (see the formula (14)).

Another method of canceling the cross talk signals estimates the cross talk signals from the cross talk gain aᵢⱼ to the MIMO channels each (see the formula (15)), and subtracts the cross talk signals from the reception signal.

As mentioned above, in the SVD-MIMO communication system relating to this embodiment, the transmitter performs the acquisition of the transmission weight matrix V, namely, the learning of V at the preparatory stage; thereafter, the transmitter does not perform the relearning of V (including a sequential or frequent relearning of V) regardless of the variations in the channel characteristic. On the other hand, the receiver updates the channel matrix H and the reception weight matrix U in order to adapt the variations of the channel characteristic. In order for this, the reference signal is sent from the transmitter at predetermined intervals (every 100 OFDM symbols in this embodiment).

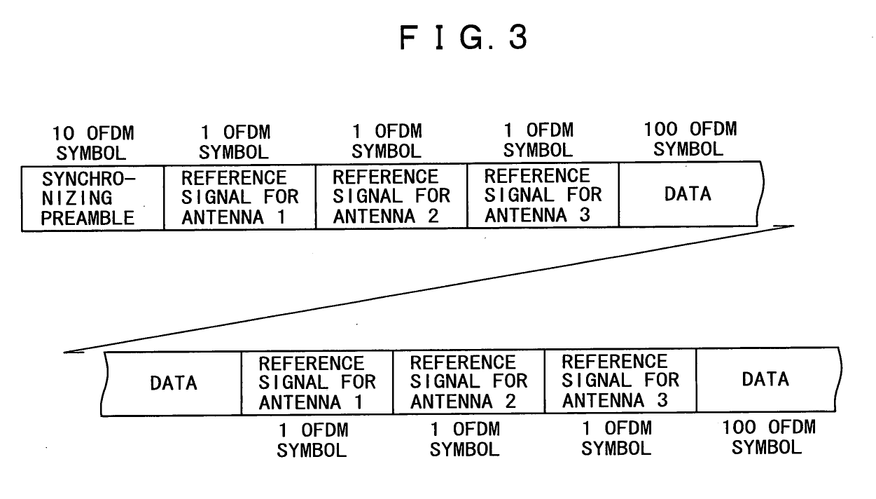

FIG. 3 illustrates a packet configuration transmitted from the transmitter. In this example, the synchronizing preamble composed of 10 OFDM symbols is sent out first, and to follow this, the reference signals each composed of 1 OFDM symbol for the antennas each are sent out. The receiver acquires the channel matrix H with the reference signal, and calculates the reception weight matrix through the singular value decomposition.

Then, after the data for 100 OFDM symbols (payload) is transmitted, the reference signals each composed of 1 OFDM symbol for the antennas each are sent out again.

The receiver acquires the new channel matrix H with the reference signals transmitted every 100 OFDM symbols, and periodically updates the reception weight matrix through the singular value decomposition. And, the receiver performs the estimation of cross talks and the removal of the cross talks through the calculation of the non-diagonal matrix Dₑᵣᵣₒᵣ, thereby achieving the signal transmission not having cross talks substantially.

As shown in FIG. 2, the communication system relating to this embodiment does not include the feedback route from the receiver to the transmitter. Since the transmission of the transmission weight matrix V is not performed, the transmission capacity will not be lowered. Since the communication is unidirectional, it is only needed to send out the synchronizing preamble at first, and the transmission capacity will not be lowered to acquire the synchronization.

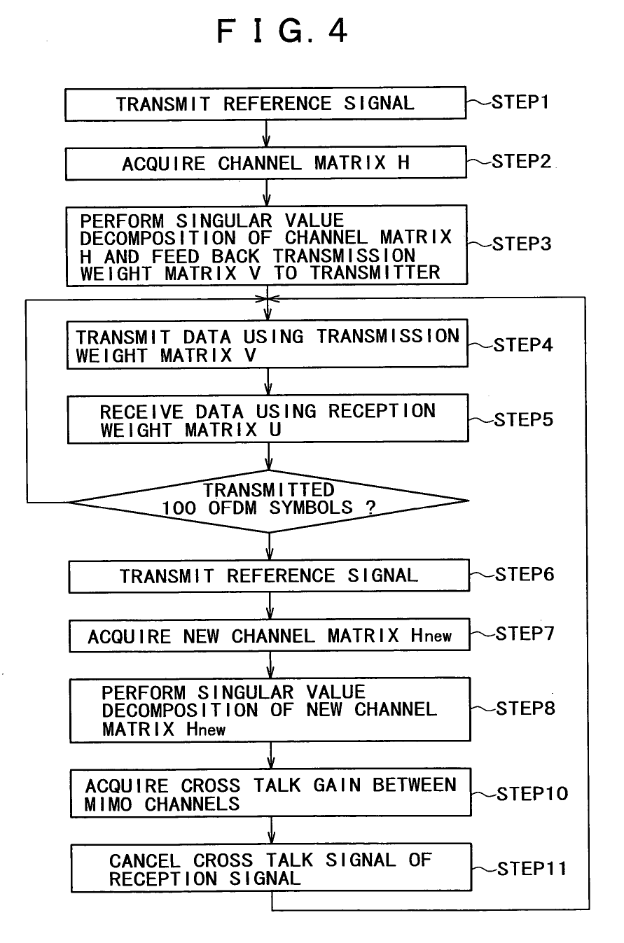

The process of the SDM-MIMO transmission in the OFDM communication system as shown in FIG. 2 will be explained with reference to FIG. 4.

Step 1:

Prior to the packet communication, the transmitter transmits the reference signals. The reference signals are transmitted in time division from the antennas each, in a manner that three antennas transmit at separate times.

Step 2:

The receiver receives the reference signals, and acquires the transfer function with the concerned reference signal, and acquires the channel matrix H integrated into a matrix form of the transfer function between the transmission antennas and the reception antennas. In this case, the channel matrix is a matrix of 3×3 (three rows by three columns).

Step 3:

The receiver performs the singular value decomposition of this acquired H to acquire UDV^{H}. And, the receiver feeds back the transmission weight matrix V to the transmitter. The receiver uses U^{H} as the reception weight.

Step 4:

The transmitter transmits 3 independent signals through 3 antennas with the fed-back transmission weight matrix V. The signals to be transmitted are the normal OFDM signal, and there merely exist three lines at the same time. Here, the 3 antennas each do not correspond to the 3 independent signals each, one logical MIMO channel uses the 3 antennas, and similarly the other MIMO channels use the 3 antennas as well.

Step 5:

The receiver separates the 3 independent data transmitted from the transmitter with U^{H}. U^{H} is a matrix of 3×3, but in reality, a matrix having three vectors of 3×1. U^{H} is the weight vector for separating only the information to which these vectors correspond.

Step 6:

The state of the transmission channel will vary, as the communication continues about 100 OFDM symbols. In order to cope with this, the transmitter transmits the reference signals. At this time in the same manner as the first time, the reference symbols are transmitted in time division from the antennas each.

Step 7:

The receiver acquires the transfer function from the transmission antennas each to the reception antennas each, using the reference signals transmitted from the transmitter, and acquires a new channel matrix H_{new} of 3×3.

Step 8:

The receiver further performs the singular value decomposition of the acquired new channel matrix H_{new}.

Step 8:
H_{new}=U_{new}D_{new}V_{new}^{H} (16)
Step 9:

The receiver, using the acquired U_{new}^{H}, separates multiple signals from the transmitter. The three signals separated in this state contain cross talks each other, and contain errors accordingly.

Step 10:

The step calculates the non-diagonal matrix Dₑᵣᵣₒᵣ.
Dₑᵣᵣₒᵣ=U_{new}⁻H_{new}V^{H-} (17)

Acquiring this matrix will define the cross talk gains between any two of the three MIMO channels each.

Step 11:

The receiver cancels the cross talk signals of the reception signal. In order to implement this, the receiver further calculates the general inverse matrix Dₑᵣᵣₒᵣ⁻ of the acquired non-diagonal matrix Dₑᵣᵣₒᵣ, multiplies a resultant signal after the reception signal having been received with the reception weight matrix by the general inverse matrix Dₑᵣᵣₒᵣ⁻, and determines the result as a final reception signal.
y=Dₑᵣᵣₒᵣ⁻U_{new}^{H}H_{new}Vx (18)

And, another method of canceling the cross talk signals is to estimate the cross talk signals from the cross talk gain aᵢⱼ to the MIMO channels calculated from the formula (13), and to subtract the estimated cross talk signals from the reception signal. Here, assuming that the original transmission signal of the j-th MIMO channel is x, and the error component thereof is xₑᵣᵣₒᵣ, the cross talk signal from the j-th MIMO channel to the i-th MIMO channel is expressed as the following formula.

$${C}_{ij} = {a}_{ij} \times ( x + {x}_{error} ) \\ = {a}_{ij} \times x + {a}_{ij} \times {x}_{error} \\ \approx {a}_{ij} \times x \qquad ( 19 )$$

Thereafter, the transmitter transmits the reference signals of the antennas each, every time it transmits the data packets for 100 OFDM symbols. The receiver updates the channel matrix repeatedly, and each time, the receiver performs the reception processing by the new reception weight matrix, the acquisition of the cross talk gains, and the canceling of the cross talk signals.

[Supplement]

The invention has been described in detail with reference to the specific embodiments. However, it is apparent for a person having ordinary skill in the art to be able to make modifications and/or substitutions of the above embodiments within the limits of not departing from the scope and spirit of the invention. That is, the above embodiments are illustrative only, and it should be well understood that the invention is not confined to the descriptions in this specification. To understand the scope and spirit of the invention, the claims described hereunder should be taken into consideration.

1. A wireless communication system in which a transmitter having multiple antennas and a receiver having multiple antennas make a pair to multiplex signals for communication, wherein:
the transmitter transmits a reference signal; and
the receiver, receiving the reference signal, calculates a channel matrix H, performs the singular value decomposition of the channel matrix H into UDV^{H} to acquire a reception weight matrix U^{H}, a diagonal matrix D, and a transmission weight matrix V, and processes a reception signal using the reception weight matrix U^{H}, and, when cross talks are generated between channels, the receiver calculates cross talk gains, estimates cross talk signals from the cross talk gains, and cancels the cross talk signals of the reception signal.

2. A wireless communication system according to claim 1, wherein the transmitter transmits the reference signal each time the transmitter transmits data of a predetermined length.

3. A wireless communication system according to claim 1, wherein:
the diagonal matrix D is turned into a non-diagonal matrix Dₑᵣᵣₒᵣ having the cross talk gains to the channels each as non-diagonal elements by the generation of cross talks; and
the receiver, using a channel matrix H_{new} newly acquired when cross talks are generated, U_{new} acquired by performing the singular value decomposition of the new channel matrix H_{new}, and the transmission weight matrix V calculated from the original channel matrix H, calculates the non-diagonal matrix Dₑᵣᵣₒᵣ according to the following formula, and thereby calculates the cross talk gains (here, U_{new}⁻ is the general inverse matrix of U_{new}, and V^{H-} is the general inverse matrix of V^{H}).
Dₑᵣᵣₒᵣ=U_{new}⁻H_{new}V^{H-} [expression 1]

4. A wireless communication system according to claim 3, wherein the receiver cancels the cross talk signals of the reception signal by calculating a general inverse matrix Dₑᵣᵣₒᵣ⁻ of the non-diagonal matrix Dₑᵣᵣₒᵣ, and multiplying a resultant signal after the reception signal having been received with the reception weight matrix U_{new} by the inverse matrix Dₑᵣᵣₒᵣ⁻ according to the following formula.
y=Dₑᵣᵣₒᵣ⁻U_{new}^{H}H_{new}Vx [expression 2]

5. A wireless communication system according to claim 3, wherein the receiver cancels the cross talk signals of the reception signal, by estimating the cross talk signals from the cross talk gains to the channels each, and subtracting the cross talk signals from the reception signal.

6. A wireless communication device having multiple antennas, which receives multiplexed signals from a transmitter having multiple antennas, the communication device comprising:
a communication unit that transmits and receives signals;
a channel estimator that calculates a channel matrix H from a reference signal transmitted from the transmitter;
a singular value decomposition unit that performs the singular value decomposition of the channel matrix H into UDV^{H} to acquire a reception weight matrix U, a diagonal matrix D, and a transmission weight matrix V;
a reception signal processor that processes a reception signal by using the reception weight matrix U;
a cross talk estimator that estimates cross talk gains to the channels each; and
a cross talk remover that estimates cross talk signals based on the cross talk gains, and removes the cross talk signals from the reception signal processed by the reception signal processor.

7. A wireless communication device according to claim 6, wherein the singular value decomposition unit, the cross talk estimator, and the cross talk remover are put into operation in response to the reference signal transmitted from the transmitter.

8. A wireless communication device according to claim 6, wherein:
the diagonal matrix D is turned into a non-diagonal matrix Dₑᵣᵣₒᵣ having the cross talk gains to the channels each as non-diagonal elements by the generation of cross talks; and
the cross talk estimator, using a channel matrix H_{new} newly acquired when cross talks are generated, U_{new} acquired by performing the singular value decomposition of the new channel matrix H_{new}, and the transmission weight matrix V calculated from the original channel matrix H, calculates the non-diagonal matrix Dₑᵣᵣₒᵣ according to the following formula, and thereby calculates the cross talk gains (here, U_{new}⁻ is the general inverse matrix of U_{new}, and V^{H-} is the general inverse matrix of V^{H}).
Dₑᵣᵣₒᵣ=U_{new}⁻H_{new}V^{H-} [expression 3]

9. A wireless communication device according to claim 6, wherein the cross talk remover removes the cross talk signals from the reception signal by calculating a general inverse matrix Dₑᵣᵣₒᵣ⁻ of the non-diagonal matrix Dₑᵣᵣₒᵣ, and multiplying a resultant signal after the reception signal having been received with the reception weight matrix U_{new} by the inverse matrix Dₑᵣᵣₒᵣ⁻ according to the following formula.
y=Dₑᵣᵣₒᵣ⁻U_{new}^{H}H_{new}Vx [expression 4]

10. A wireless communication device according to claim 6, wherein the cross talk remover removes the cross talk signals from the reception signal, by estimating the cross talk signals from the cross talk gains to the channels each, and subtracting the cross talk signals from the reception signal.

11. A wireless communication method for receiving multiplexed signals from a transmitter having multiple antennas by using multiple antennas, comprising:
a channel estimating step that calculates a channel matrix H from a reference signal transmitted from the transmitter;
a singular value decomposition step that performs the singular value decomposition of the channel matrix H into UDV^{H} to acquire a reception weight matrix U, a diagonal matrix D, and a transmission weight matrix V;
a reception signal processing step that processes a reception signal by using the reception weight matrix U;
a cross talk estimating step that estimates cross talk gains to the channels each; and
a cross talk removing step that estimates cross talk signals based on the cross talk gains, and removes the cross talk signals from the reception signal processed by the reception signal processing step.

12. A wireless communication method according to claim 11, wherein the singular value decomposition step, the cross talk estimating step, and the cross talk removing step are put into operation in response to the reference signal transmitted from the transmitter.

13. A wireless communication method according to claim 11, wherein:
the diagonal matrix D is turned into a non-diagonal matrix Dₑᵣᵣₒᵣ having the cross talk gains to the channels each as non-diagonal elements by the generation of cross talks; and
the cross talk estimating step, using a channel matrix H_{new} newly acquired when cross talks are generated, U_{new} acquired by performing the singular value decomposition of the new channel matrix H_{new}, and the transmission weight matrix V calculated from the original channel matrix H, calculates the non-diagonal matrix Dₑᵣᵣₒᵣ according to the following formula, and thereby calculates the cross talk gains (here, U_{new}⁻ is the general inverse matrix of U_{new}, and V^{H-} is the general inverse matrix of V_{H}).
Dₑᵣᵣₒᵣ=U_{new}⁻H_{new}V^{H-} [expression 3]

14. A wireless communication device according to claim 13, wherein the cross talk removing step removes the cross talk signals from the reception signal by calculating a general inverse matrix Dₑᵣᵣₒᵣ⁻ of the non-diagonal matrix Dₑᵣᵣₒᵣ, and multiplying a resultant signal after the reception signal having been received with the reception weight matrix U_{new} by the inverse matrix Dₑᵣᵣₒᵣ⁻ according to the following formula.
y=Dₑᵣᵣₒᵣ⁻U_{new}^{H}H_{new}Vx [expression 4]

15. A wireless communication device according to claim 13, wherein the cross talk removing step removes the cross talk signals from the reception signal, by estimating the cross talk signals from the cross talk gains to the channels each, and subtracting the cross talk signals from the reception signal.

16. A computer program described in a computer-readable format, in a manner that the processing for receiving multiplexed signals from a transmitter having multiple antennas with multiple antennas is executed on a computer system, comprising:
a channel estimating step that calculates a channel matrix H from a reference signal transmitted from the transmitter;
a singular value decomposition stop that performs the singular value decomposition of the channel matrix H into UDV^{H} to acquire a reception weight matrix U^{H}, a diagonal matrix D, and a transmission weight matrix V;
a reception signal processing step that processes a reception signal by using the reception weight matrix U^{H};
a cross talk estimating step that estimates cross talk gains to the channels each; and
a cross talk removing step that estimates cross talk signals based on the cross talk gains, and removes the cross talk signals from the reception signal processed in the reception signal processing step.
